(19) United States
(12) Patent Application Publication
(10) Pub. No.: US 2013/0198626 A1
(43) Pub. Date: Aug. 1, 2013

(54) ELECTRONIC DEVICE AND SERVER

(71) Applicant: Miki SAIJO, Kumagaya-shi (JP)

(72) Inventor: Miki SAIJO, Kumagaya-shi (JP)

(73) Assignee: Kabushiki Kaisha Toshiba, Tokyo (JP)

(21) Appl. No.: 13/603,023

(22) Filed: Sep. 4, 2012

(30) Foreign Application Priority Data
Jan. 31, 2012 (JP) 2012-019338

(51) Int. Cl. G06F 15/16; G06F 3/048

(52) U.S. Cl. 715/705; 709/217

(57) ABSTRACT

According to one embodiment, an electronic device communicating with a server includes a transmitter, a receiver and a display controller. The transmitter is configured to transmit, to the server, at least one of setting information of an application set by a user and setting information set in the electronic device by the user. The receiver is configured to receive, from the server, answer information to anticipated user's questions in accordance with the setting information. The display controller is configured to controls to display the answer information.

### CROSS-REFERENCE TO RELATED APPLICATION(S)

This application is based upon and claims the benefit of priority from Japanese Patent Application No. 2012-19338, filed Jan. 31, 2012; the entire contents of which are incorporated herein by reference.

### BACKGROUND

### Technical Field

Embodiments of the invention relates generally to an electronic device and a server for displaying FAQ's (Frequency Asked Questions, Frequently-Asked Questions, or Frequently Asked Questions, etc.), for example, in accordance with user's setting.

### BRIEF DESCRIPTION OF THE DRAWINGS

FIG. 1 is an exemplary functional block configuration diagram (when an eManual is displayed) according to one embodiment;

FIG. 2 is an exemplary functional block configuration diagram (when an error is displayed) according to another embodiment;

FIG. 3 is an exemplary functional block configuration diagram for explaining transmission of user's answer information, according to one embodiment;

FIG. 4 is an exemplary sequence diagram showing a flow of events when a CSP processes an HTTP request;

FIG. 5 is an exemplary appearance view showing an example of a remote controller according to one embodiment;

FIG. 6 is an exemplary block diagram showing an example of an internal configuration including a DTV and a remote controller according to one embodiment; and

FIG. 7 is an exemplary diagram showing a system configuration of an information processing device (server) according to one embodiment.

### DETAILED DESCRIPTION

Various embodiments will be described hereinafter with reference to the accompanying drawings.

According to one embodiment, an electronic device communicating with a server includes a transmitter, a receiver and a display controller. The transmitter is configured to transmit; to the server, at least one of setting information of an application set by a user and setting information set in the electronic device by the user. The receiver is configured to receive, from the server, answer information to anticipated user's questions in accordance with the setting information. The display controller is configured to controls to display the answer information.

First, an image display system including a DTV 10 and a remote controller 20 will be described in detail below as an example of an image display system according to this embodiment.

The DTV 10 is a digital television as an example of an electronic device in this embodiment. The DTV 10 has a function of extracting video/audio information from broadcast signals of a received broadcast wave and outputting the extracted video/audio information. In addition, the DTV 10 is connected to a wide area network (WAN) such as the Internet so that the DTV 10 can communicate with other devices connected to the WAN. Although the DTV 10 is shown here as an example of the electronic device according to this embodiment, the electronic device is not limited thereto. Various devices such as a PC (Personal Computer) may be regarded as other examples of the electronic device.

The remote controller 20 has a plurality of operation switches (keys). The remote controller 20 has a function of transmitting a signal for operating the DTV 10 in response to one of the operation switches when the operation switch is pushed down. It is general that, for example, an RF (Radio Frequency) signal or an IR (Infrared) signal is used in terms of the format of the signal. However, signals may be transmitted either in a wireless manner or a wired manner in this embodiment.

The image display system includes the DTV 10 and the remote controller 20. A user may operate the DTV 10 using the remote controller 20 to perform a predetermined process to display an image.

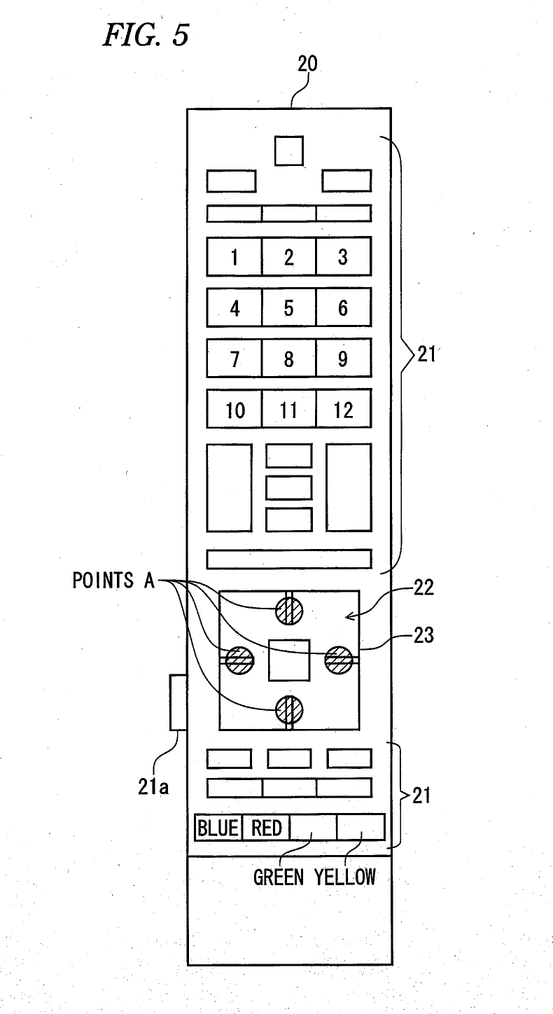

The detailed structure of the remote controller 20 will be described next. FIG. 5 is an exemplary appearance view showing an example of the remote controller 20 in this embodiment.

The remote controller 20 has the plurality of keys (switches) for operating various functions of the DTV 10. In this embodiment, the plurality of keys include keys 21, a touch pad 22, cross keys 23 and a side key 21a.

The keys 21 are keys for executing various functions of the DTV 10. The remote controller 20 transmits different operation signals according to the keys pushed by a user. The keys 21 include various keys such as a power key for powering on/off the DTV 10, an input changeover key for changing over a source of video information to be displayed, a group of input changeover keys for selecting a game, a digital terrestrial broadcast, a BS broadcast and a CS broadcast respectively, a group of channel character keys for selecting channels, inputting characters, etc. respectively, a channel changeover key for changing over a channel, a screen display key for selecting a display format of a screen, a volume control key for controlling a volume, color keys to which colors are assigned for executing various functions of the DTV 10, etc. The keys 21 also include an enter key for making a selecting operation when a cursor displayed on the DTV 10 is located in a predetermined position. In the description of this embodiment, these keys including the keys 21a will be collectively called the key 21 for the sake of convenience. However, the touch pad 22 and the cross keys 23 will be described separately from the keys 21.

The touch pad 22 has a function of detecting a touch of a user's finger or the like on a front surface of the touch pad 22 as a change of capacitance, and outputting a detection signal indicating the detected point. The user can operate the cursor displayed on the DTV 10 by tracing the front surface of the touch pad 22 with a user's finger.

The cross keys 23 are provided inside the remote controller 20 so as to be located opposite to a rear surface of the touch pad 22. As soon as the rear surface of the touch pad 22 pushed down by the user is brought into contact with one of the cross keys 23, the cross key 23 detects the pressure and outputs a detection signal. The cross keys 23 are provided with four switches which are assigned to upper, lower, left and right points A located inside the remote controller 20 as shown in FIG. 5. The cross keys 23 including the four switches output signals indicating the upper, lower, left and right directions, respectively.

In this embodiment, the touch pad 22 in the remote controller 20 is provided so as to be integrated with the cross keys 23 (the touch pad 22 serves also as the cross keys 23). When the user pushes down one of the cross keys 23, the user touches the touch pad 22 with a user's finger. At this time, the touch pad 22 and the cross key 23 output detection signals, respectively.

Although this embodiment has been described along the example in which the touch pad 22 and the cross keys 23 are provided in the same place in the remote controller 20 when viewed from the outside, the invention is not limited thereto. Alternatively, the touch pad 22 and the cross keys 23 may be provided in different places independently and respectively.

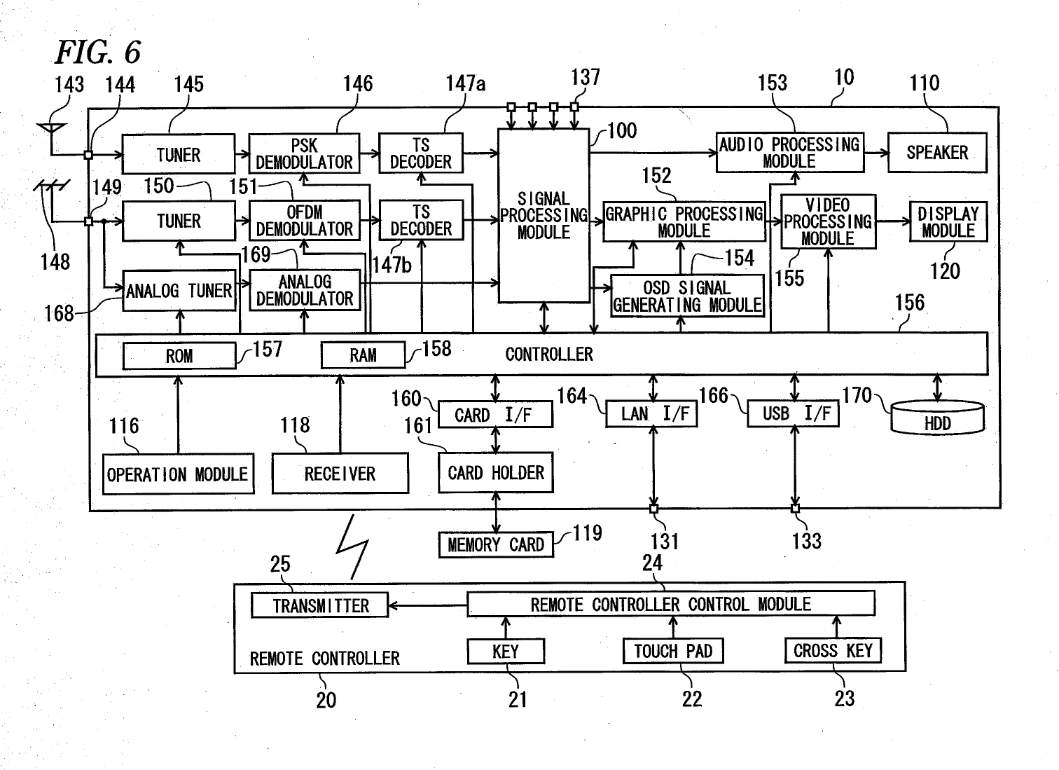

Description will be made next on the internal configuration of the DTV 10 and the remote controller 20 in the image display system. FIG. 6 is a block diagram showing an example of the internal configuration of the DTV 10 and the remote controller 20 in this embodiment. First, the DTV 10 will be described.

The DTV 10 has a controller 156 for controlling the operation of respective portions of the DTV 10. The controller 156 has a built-in CPU (Central Processing Unit), etc. The controller 156 activates a system control program and various processing programs stored in an ROM (Read Only Memory) 157 in advance, in accordance with an operation signal input from an operation module 116 or an operation signal transmitted from the remote controller 20 and received through a receiver 118. The controller 156 controls the operation of the respective portions of the DTV 10 using an RAM (Random Access Memory) 158 as a work memory in accordance with the activated programs.

Satellite digital television broadcast signals received by a BS/CS digital broadcast receiving antenna 143 are supplied to a satellite digital broadcast tuner 145 through an input terminal 144. The tuner 145 tunes in to one of the received digital broadcast signals, and transmits the tuned digital broadcast signal to a PSK (Phase Shift Keying) demodulator 146. The PSK demodulator 146 demodulates the digital broadcast signal into a TS (Transport Stream), and supplies the demodulated TS to a TS decoder 147a. The TS decoder 147a decodes the TS into a digital signal including a digital video signal, a digital audio signal and a data signal, and then supplies the decoded digital signal to a signal processing module 100. Here, the digital video signal is a digital signal relating to video which the DTV 10 can output whereas the digital audio signal is a digital signal relating to audio which the DTV 10 can output. On the other hand, the data signal is a digital signal relating to information about a broadcast program of a broadcast wave including program-relevant information etc. as information which is used when the DTV 10 generates an. EPG (Electronic Program Guide) as an electronic program table.

Terrestrial digital television broadcast signals received by a terrestrial digital broadcast receiving antenna 148 are supplied to terrestrial digital broadcast tuners 150 through an input terminal 149. The tuners 150 tune the received digital broadcast signals, and transmit the tuned digital broadcast signals to OFDM (Orthogonal Frequency Division Multiplexing) demodulators 151, respectively. The OFDM demodulators 151 demodulate the digital broadcast signals into TS's, and supply the demodulated TS's to TS decoders 147b, respectively. The TS decoders 147b decode the TS's into digital video and audio signals etc., and then supply the decoded digital video and audio signals etc. to the signal processing module 100. The terrestrial digital television broadcasts acquired by the eleven tuners 150 can be decoded into digital signals each including a digital video signal, a digital audio signal and a data signal by the OFDM demodulators 151 and the TS decoders 147b concurrently, and then output to the signal processing module 100.

The antenna 148 can also receive terrestrial analog broadcast signals. The received terrestrial analog broadcast signals are distributed by a distributor not shown, and supplied to an analog tuner 168. The analog tuner 168 tunes in to one of the received analog broadcast signals, and transmits the tuned analog broadcast signal to an analog demodulator 169. The analog demodulator 169 demodulates the analog broadcast signal, and outputs the demodulated analog broadcast signal to the signal processing module 100. In addition, CATV (Common Antenna Television) can be also watched and listened to on the DTV 10 when a CATV tuner is connected to the input terminal 149 so as to be substituted for the antenna 148 connected to the input terminal 149.

The signal processing module 100 performs appropriate signal processing on the digital signal output from the TS decoder 147a or 147b or the controller 156. More specifically, the signal processing module 100 separates the digital signal into a digital video signal, a digital audio signal and a data signal. The separated video signal is output to a graphic processing module 152, and the separated audio signal is supplied to an audio processing module 153. In addition, the signal processing module 100 converts the broadcast signal output from the analog demodulator 169 into video and audio signals in a predetermined digital format. The converted digital video signal is output to the graphic processing module 152, and the converted digital audio signal is output to the audio processing module 153. The signal processing module 100 further performs predetermined digital signal processing on an input signal supplied from a line input terminal 137.

An OSD (On Screen Display) signal generating module 154 generates an OSD signal for displaying a UI (User Interface) screen or the like under the control of the controller 156. In addition, the data signal separated from the digital broadcast signal by the signal processing module 100 is converted into an OSD signal in a suitable format by the OSD signal generating module 154, and output to the graphic processing module 152.

The graphic processing module 152 decodes the digital video signal output from the signal processing module 100. The decoded video signal is combined with the OSD signal output from the OSD signal generating module 154 by means of superposition, and is output to a video processing module 155. The graphic processing module 152 may output either the decoded video signal or the OSD signal to the video processing module 155 selectively.

The video processing module 155 converts the signal output from the graphic processing module 152 into an analog video signal in a format which a display module 120 can display. The converted analog video signal is displayed on the display module 120.

The audio processing module 153 converts the input audio signal into an analog audio signal in a format which a speaker 110 can output. The converted analog audio signal is output to and reproduced by the speaker 110.

A card holder 161 is connected to the controller 156 through a card I/F (Interface) 160. A memory card 119 can be attached to the card holder 161. The memory card 119 is a storage medium such as an SD (Secure Digital) memory card, an MMC (Multimedia Card), a CF (COMPACTFLASH (registered trademark)) card, or the like. The memory card 119 attached to the card holder 161 can work with the controller 156 to write/read information through the card I/F 160.

An LAN terminal 131 is connected to the controller 156 through an LAN I/F 164. The LAN terminal 131 is used as a general LAN support port using Ethernet (registered trademark). In this embodiment, an LAN cable (not shown) is connected to the LAN terminal 131 so that the controller 156 can communicate with the Internet.

A USB (Universal Serial Bus) terminal 133 is connected to the controller 156 through a USB I/F 166. The USB terminal 133 is used as a general USB-support port. For example, a cellular phone, a digital camera, a card reader/writer for supporting various memory cards, an HDD, a keyboard, etc. may be connected to the USB terminal 133 through a hub. The controller 156 can perform information communication (transmission/reception) with devices connected through the USB terminal 133.

An HDD 170 is a magnetic storage medium (Hard Disk Drive) built in the DTV 10. The HDD 170 has a function of storing various kinds of information belonging to the DTV 10.

The remote controller 20 will be described next.

Each of detection signals output from the keys 21, the touch pad 22 and the cross keys 23 is input to a remote controller control module 24. The remote controller control module 24 generates an operation signal for operating the DTV 10 based on the input signal, and transmits the operation signal to the outside through a transmitter 25. When the receiver 118 receives the transmitted operation signal, the DTV 10 executes predetermined processing in accordance with the received operation signal.

In this embodiment, a signal transmitted from the remote controller 20 in accordance with pushing down of the key 21 is referred to as a key operation signal, a signal transmitted in accordance with tracing of the touch pad 22 is referred to as a touch pad operation signal, and a signal transmitted in accordance with pushing down of one of the cross keys 23 is referred to as a cross key operation signal. According to the above description, a signal transmitted in accordance with the side key 21 a is a kind of the key operation signal. However, the signal transmitted in accordance with the side key 21a will be referred to as a side key operation signal below when it has to be distinguished from the key operation signal in expression.

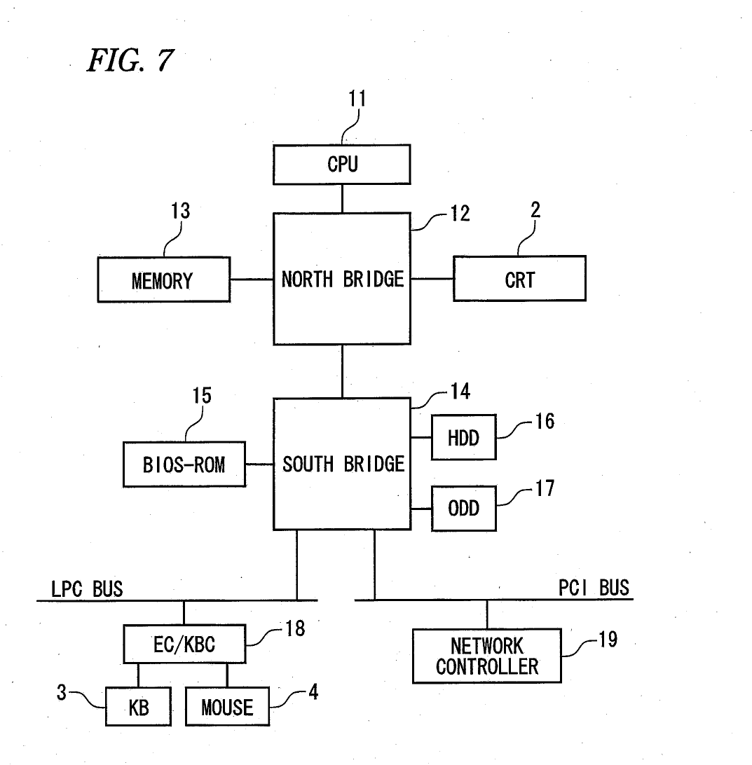

On the other hand, FIG. 7 exemplarily shows an example of the system configuration of hardware, etc. of the server 1.

As shown in FIG. 7, the server 1 has a CPU 11, a north bridge 12, a main memory 13, a south bridge 14, a BIOS-ROM 15, a magnetic disk drive device (HDD) 16, a magneto-optical disk drive device (ODD) 17, an embedded controller/keyboard controller IC (EC/KBC) 18, a network controller 19, etc.

The CPU 11 is a main processor for controlling the operation of the server 1. The CPU 11 executes an operating system, various application programs and utility programs loaded from the HDD 16 onto the main memory 13.

The north bridge 12 is a bridge device for connecting a local bus of the CPU 11 and the south bridge 14 to each other. The north bridge 12 has a built-in display controller for controlling a CRT display 2, and a built-in memory controller for controlling the main memory 13.

The south bridge 14 serves as an I/O controller for controlling various I/O devices which are, for example, connected to a PCI (Peripheral Component Interconnect) bus and an LPC (Low Pin Count) bus. In addition, the south bridge 14 has built-in IDE (Integrated Drive Electronics) for controlling the HDD 16 and the ODD 17. Access to the BIOS-ROM 15 is also controlled by the south bridge 14. The BIOS-ROM 15 is a flash ROM which stores a system BIOS electrically rewritably.

The EC/KBC 18 is a one-chip microcomputer in which an embedded controller for management of power supply and a keyboard controller for controlling a keyboard (KB) 3, a mouse 4, etc. are integrated. The network controller 19 controls data communication with other computers through LAN.

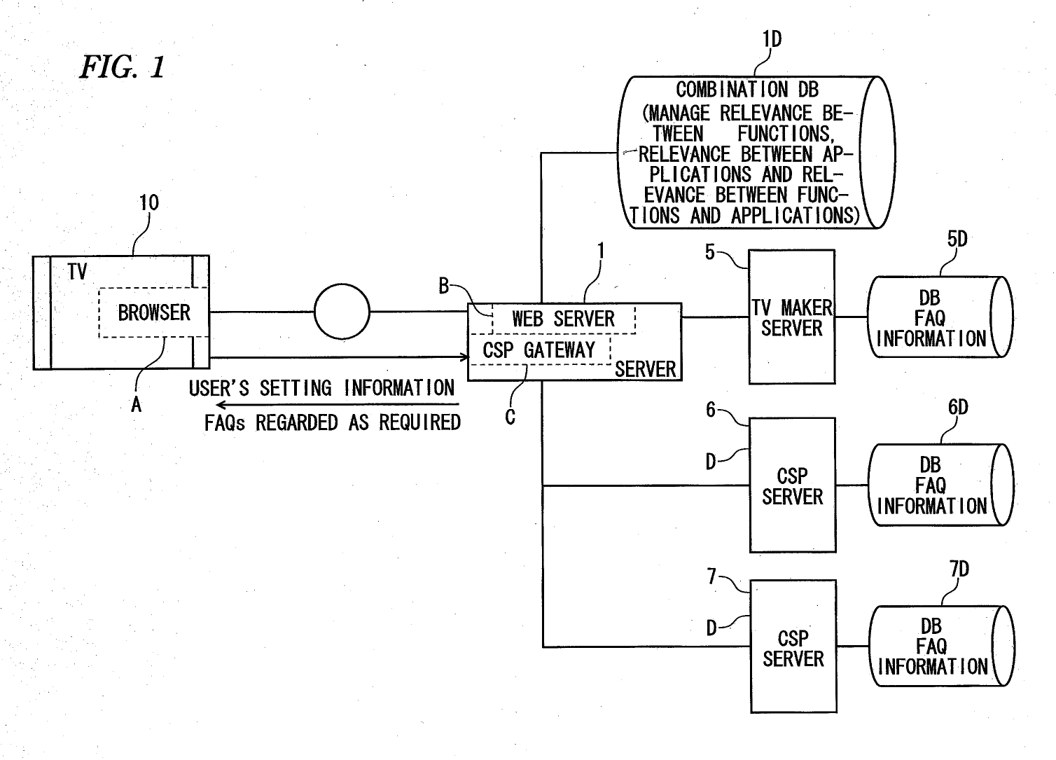

A system shown in FIG. 1 may be configured based on the aforementioned example of the hardware configuration. That is, FIG. 1 is an exemplary functional block configuration diagram (at the time of display of eManual (electronic manual)) according to one embodiment. It is assumed that the DTV 10 (hereinafter referred to as. TV) serving as a display device is an eManual-installed TV which can be connected to a server through a network. Data usually used for the eManual may be provided in the TV or may be provided on the server side. The eManual includes help information which is called when the side key 21a is pushed down.

The TV is connected to the server 1 through a network. On the other hand, the server 1 is connected to a TV maker server 5 and two CSP (Cache' Server Pages; which will be described later) servers 6 and 7 as representatives through a network. A combination DB (database) 1D which will be described later is further connected to the server 1. DBs 5D, 6D and 7D which are DBs including FAQ information (question information) for the TV maker server 5 and the CSP servers 6 and 7 themselves are connected to the TV maker server 5 and the CSP servers 6 and 7, respectively. The constituent members A to D will be described later.

For example, when the eManual is displayed on the TV 10 in FIG. 1 during use of an application (for example, during use of online DVD rental etc. such as Netflix ((R); which will be omitted below)), the whole behavior will be schematically described in the following sequence.

(1) The TV 10 sends, to the server 1, user's setting information including application information (about Internet phone service etc. using P2P technology, such as Skype ((R); which will be omitted below) Incoming call on) and functions (e.g. Channel setting, Menu Language, setup, and so on).

The setting information may mean application information (Skype Incoming call on setting) and functions (Channel setting, Menu Language, setup, and so on) set by a user. The setting information is transmitted to the server 1 to thereby narrow down FAQ information to FAQs (Frequency Asked Questions, Frequently-Asked Questions, Frequently Asked Questions, etc.) concerned with (Skype Incoming call on, Menu Language) relating to Netflix, based on the combination DB 1D.

(2) The server 1 inquires each CSP server (6, 7 or the like) controlling (Skype) and so on or inquires the maker server 5, and acquires required FAQ information from the DB*D (*=5, 6, 7). The FAQ information forms an information group of preliminarily planned answers to anticipated user's questions.
(3) FAQ information having relevance between functions of the TV, relevance between applications and relevance between the functions of the TV and the applications (FAQs concerned with Skype Incoming call on in Netflix, FAQs associated with Netflix such as Menu Language) is narrowed down in the combination DB 1D. For example, the relevance between the functions of the TV and the applications includes relevance between terrestrial digital channels and sound quality etc. For example, sound quality with a wide dynamic range is set when a classical music program is on air. Also, sound quality with high articulation is set when a talk show program is on air.
(4) The server 1 sends the narrowed FAQ information to the TV 10.
(5) The TV 10 displays the FAQ information together with the eManual.

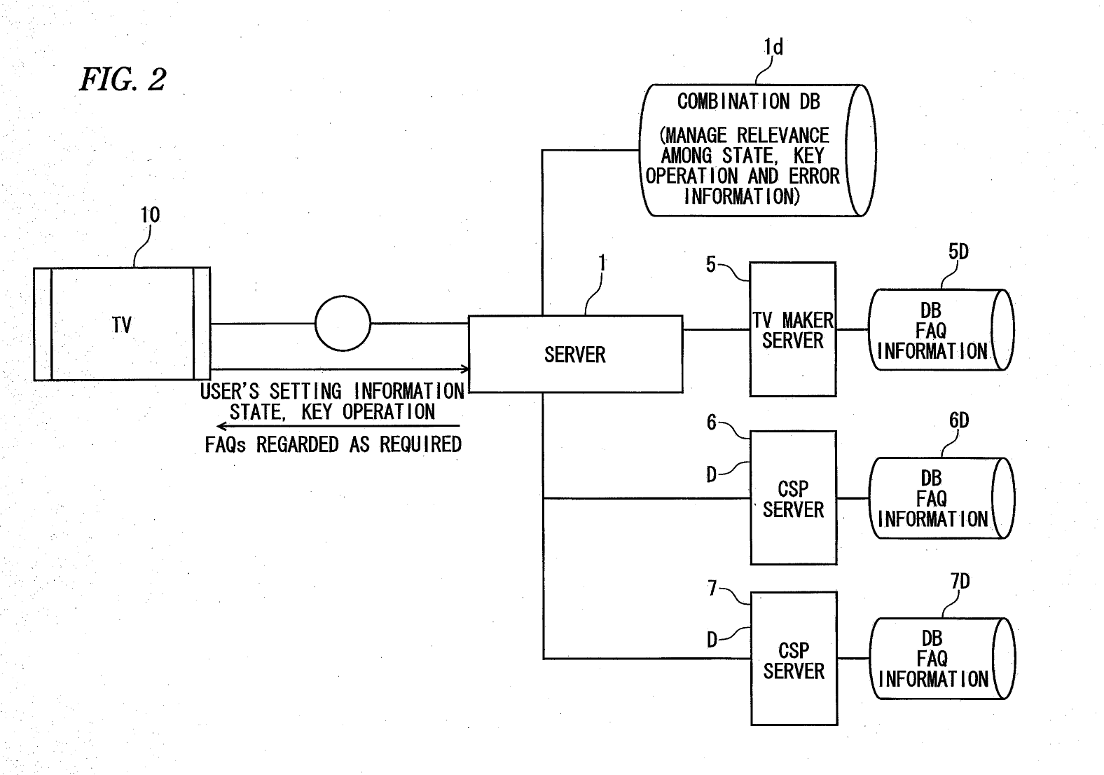

In addition, a system shown in FIG. 2 may be configured based on the example of the hardware configuration shown in FIGS. 5 to 7. That is, FIG. 2 is an exemplary functional block configuration diagram (at the time of display of an error) according to another embodiment. The functional configuration of FIG. 2 is different from that of FIG. 1 in that a combination DB 1d in place of the combination DB 1D is connected to the server 1.

In the TV in FIG. 2, for example, the whole behavior will be schematically described in the following sequence when error processing is displayed during operation (during use of online DVD rental etc., such as Netflix).

(1) The TV sends, to the server 1, user's setting information including application information (about Internet phone service etc. using P2P technology, such as Skype ((R); which will be omitted below) Incoming call on) and functions (e.g. Channel setting, Menu Language, setup, and so on).

The setting information may mean application information (Skype Incoming call on setting) and functions (Channel setting, Menu Language, setup, and so on) set by a user. The setting information is transmitted to the server 1 to thereby narrow down FAQ information to FAQs (Frequency Asked Questions, Frequently-Asked Questions, Frequently Asked Questions, etc.) concerned with (Skype Incoming call on, Menu Language) relating to Netflix based on the combination DB (database) 1d.

(2) The server 1 inquires each CSP server (6, 7 or the like) controlling (Skype) and so on or inquires the maker server 5, and acquires required FAQ information from the DB*D (*=5, 6, 7).
(3) FAQ information (FAQs concerned with Skype Incoming call on in Netflix, FAQs associated with Netflix such as Menu Language) relevant to state, key operation and error information is narrowed down in the combination DB 1d. For example, the relevance among the TV state, the key operation and the error information includes relevance between state and key operation etc. For example, some kinds of alerts (warnings) are often displayed in response to specific key operations when a recorded program is being dubbed. A cause and a measure to avoid the cause are provided for error information displayed in the form of such an alert.
(4) The server 1 sends the narrowed FAQ information for an error to the TV 10.
(5) The TV 10 displays the FAQ information after displaying the error.

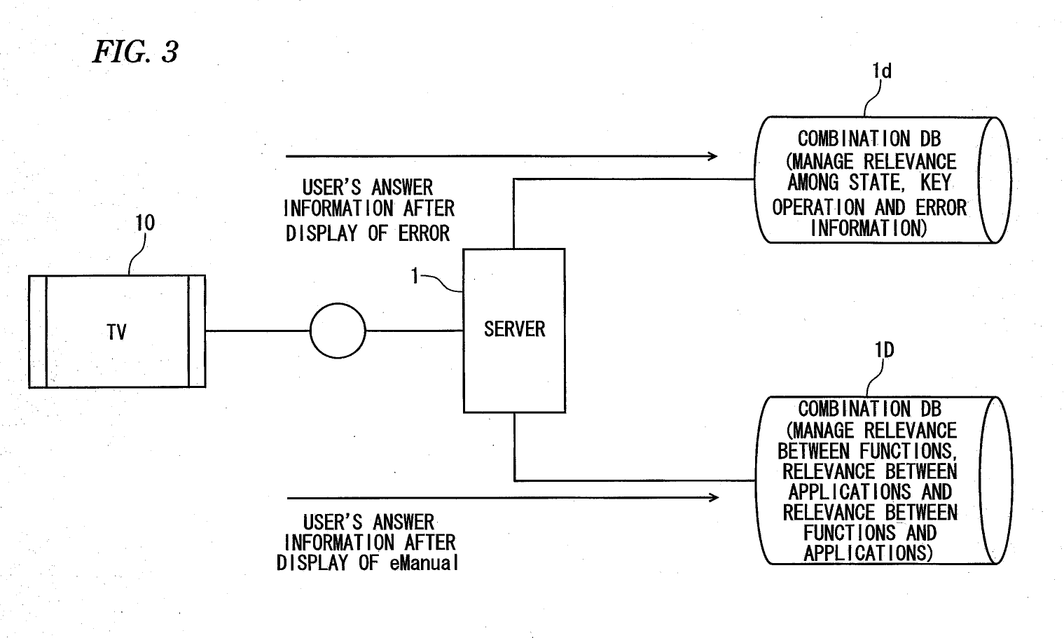

In addition, FIG. 3 is an exemplary functional block configuration diagram for explaining transmission of user's operation information according to this embodiment. In the TV 10 after displaying the FAQ information in FIGS. 1 and 2, for example, the whole behavior will be described in the following sequence.

After the eManual is displayed in FIG. 1, the user selects FAQ information (selects FAQs concerned with Skype Incoming call on in Netflix). As a result, operation information thereof is sent from the TV 10 to the combination DB 1D of the server 1. By this selection, the user selects FAQ information concerned with Skype Incoming call on from the narrowed FAQ information (Skype Incoming call on, Menu Language).

On the other hand, the user selects FAQ information (selects FAQs concerned with Menu Language) after display of an error in FIG. 2 to thereby send operation information thereof to the combination DB of the server. By this selection, the user selects FAQ information concerned with Menu Language from the narrowed FAQ information (Skype Incoming call on, Menu Language).

Here, the configuration and operation of each CSP used in the configurations of FIGS. 1 to 3 will be described additionally.

The CSP provides dynamic contents in response to a received HTTP (Hypertext Transport Protocol) request. Basic contents about how HTTP is processed in the CSP will be described below.

HTTP is a simple protocol with which a client sends a request to a server. HTTP is a stateless protocol, in which the client and the server are connected only for a period necessary for the client and the server to exchange the request. Any HTTP request has a request header for designating a request type (GET, POST, etc.), URL, and a version number. In addition, some HTTP requests have additional information. The CSP automatically determines which HTTP request is to be processed, distributes the determined HTTP request to a suitable class in the Cache' server, and collects information of the request in an object (such as % CSP.Request object) which is easy to use.

The following architectures of a CSP and an HTTP request may be used in the execution environment of CSP shown in FIG. 1. The execution environment of CSP shown in FIGS. 2 and 3 are similar to that shown in FIG. 1 although the symbols A to D are omitted there.

A. HTTP client (Web browser, etc.)
B. HTTP server (Web server of Apache ((R), which will be omitted hereafter) or IIS ((R), which will be omitted hereafter)
C. CSP gateway (Cache' add-on to the Web server)
D. Cache' server (server serving as a place where a requested CSP application will be executed in the CSP server)

Of them, the CSP gateway is placed in the same hardware as the Web server.

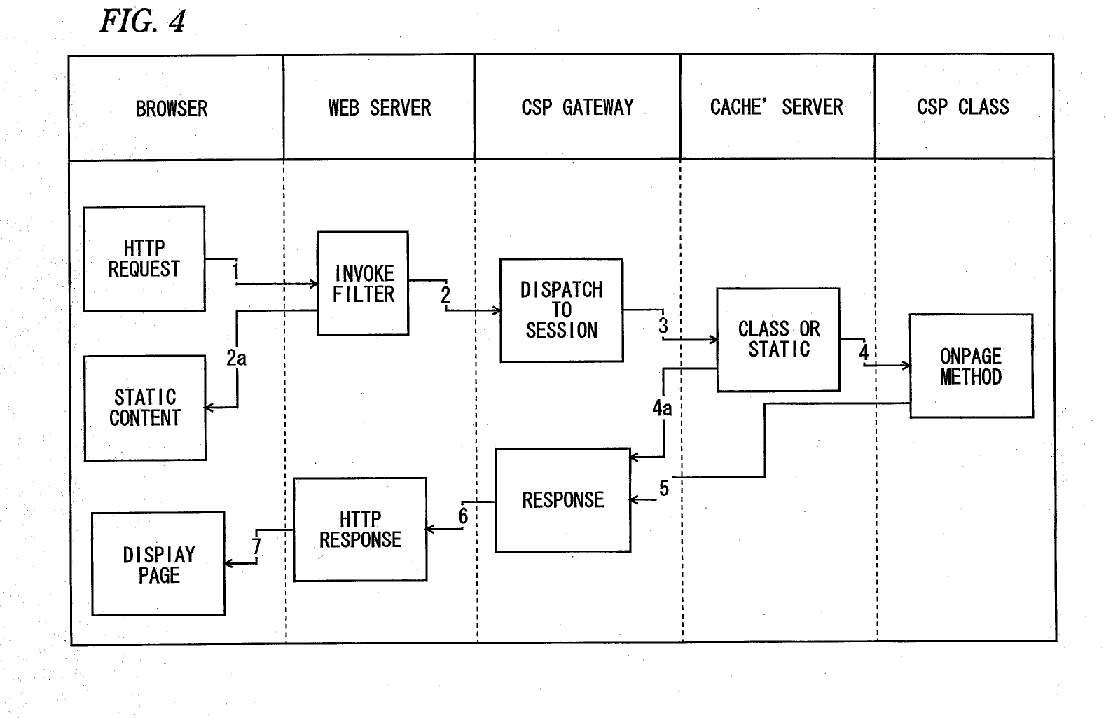

Next, FIG. 4 exemplarily shows the following flow of events when a CSP processes an HTTP request.

1. A browser (or a similar Web client) generates an HTTP request.
2. A Web server determines that the HTTP request is a CSP request, and transmits the request to a CSP gateway installed in the Web server. In some application configuration, the Web server may process static contents as 2a.
3. The CSP gateway rearranges the request again and transmits the request to a suitable Cache' server.
4. The Cache' server decodes a message and determines whether the request is issued to a static page or to a CSP class.

If the request is issued to a static file such as .html or .jpg, the Cache' server finds out the file in a local file system, and sends contents of the file as 4a back to the client.

If the request is issued to a class, the Cache' server determines which class, from among event processing classes constituting the application, processes an event, and calls a Page method of the class.

5. An output of the Page method or the static page is sent back as an HTTP response to the CSP gateway.
6. The CSP gateway sends the HTTP response to the Web server (specifically, the response is sent back to the Web server via the CSP gateway).
7. The Web server sends the response back to the Web browser, and the Web browser processes the response. In the case of HTML, the contents of the response are displayed.

### Key Points of Embodiments

1. User's setting information of the TV is transmitted to a server, the number of FAQs (Frequency Asked Questions, Frequently-Asked Questions or Frequently Asked Questions) is narrowed down in a combination DB based on the setting information, and the narrowed FAQs are displayed together with an eManual (electronic manual).
2. The user's setting information is setting information of functions provided in the TV and applications downloaded through a network by the user.
3. The combination DB is a database for managing relevance between the TV functions, relevance between the applications and relevance between the TV functions and the applications in the case of display on the eManual, and a database for managing relevance among state, user's key operation and error information in the case of display of an error.

### Advantages of Embodiments

(A) DL (Download) time is shortened because only information required by the user is downloaded.
(B) The user himself/herself does not have to download FAQs.
(C) Wasteful DL time can be avoided because the information is acquired upon activation of the FAQs (question function) of the eManual.
(D) Required help information suitable to the user can be acquired. Information which the user wants to know can be acquired when the user wants to know the information.
(E) Operation information of the user is transmitted so that FAQ information more effective for another user can be acquired (in the case of FIG. 3).

In the above embodiments, providing FAQ's based on setting information of the device has been described. The following items will be added to the key points of the embodiments.

1. User's setting information of the TV is transmitted to a server, the number of FAQs (Frequency Asked Questions, Frequently-Asked Questions or Frequently Asked Questions) is narrowed down in a combination DB based on the setting information, and the narrowed FAQs are displayed together with an eManual (electronic manual).
2. The user's setting information is setting information of functions provided in the TV and applications downloaded through a network by the user.
3. The combination DB is a database for managing relevance between the TV functions, relevance between the applications and relevance between the TV functions and the applications in the case of display on the eManual, and a database for managing relevance among state, user's key operation and error information in the case of display of an error.
4. The FAQ information in the item 1 is acquired upon activation of the eManual.
5. FAQs corresponding to the user's setting information, state and key operation are displayed when the error is displayed during user's operation on the TV.
6. The FAQ information in the item 5 is acquired as soon as the error is displayed.
7. The user's operation information leading to the FAQ information in the case of eManual display and the user's operation information leading to the FAQ information in the case of error display are sent to the combination DB of the server. The invention is not limited to the aforementioned embodiments, but various modifications may be made on the invention in a practical stage without departing from the gist of the invention.

In addition, a plurality of constituent members disclosed in the aforementioned embodiments may be suitably combined to form various inventions. For example, some may be removed from the whole constituent members shown in the embodiments. Further, constituent members according to different embodiments may be combined suitably. For example, the server 1 and the TV maker server 5 may be formed to be integrated with each other.

What is claimed is:

1. An electronic device communicating with a server, comprising:
a transmitter configured to transmit, to the server, at least one of setting information of an application set by a user and setting information set in the electronic device by the user;
a receiver configured to receive, from the server, answer information to anticipated user's questions in accordance with the setting information; and
a display controller configured to controls to display the answer information.

2. The electronic device according to claim 1, wherein the receiver receives the answer information upon a question function of an electronic manual which is received from the server or which is stored.

3. The electronic device according to claim 1, wherein the receiver receives the answer information when user's operation causes an error.

4. The electronic device according to claim 2, wherein the receiver receives the answer information when user's operation causes an error.

5. The electronic device according to claim 1, wherein
the receiver receives a broadcast program, and
the setting information includes relevance between the broadcast program and sound quality with which the broadcast program is reproduced.

6. The electronic device according to claim 1, wherein the answer information to the anticipated user's questions includes question information based on the setting information.

7. The electronic device according to claim 1, wherein the display controller controls to display both the electronic manual, which is received from the server or stored, and the answer information to the anticipated user's questions.

8. The electronic device according to claim 1, wherein the transmitter transmits user's operation information corresponding to the answer information.

9. A server comprising:
a receiver configured to receives, from an electronic device, at least one of setting information of an application set by a user of the electronic device and setting information set in the electronic device by the user; and
a transmitter configured to transmit, to the electronic device, answer information to anticipated user's questions in accordance with the setting information.

10. The server according to claim 9, wherein the setting information includes setting information about a function provided in the electronic device or an application installed in the electronic device.

11. The server according to claim 10, further comprising:
a storage configured to store combinations of relevance between functions of the electronic device, relevance between applications and relevance between the functions of the electronic device and the applications, wherein
the storage narrows down the number of pieces of answer information to the anticipated user's questions.
